(19) United States
(12) Patent Application Publication
(10) Pub. No.: US 2004/0049504 A1
(43) Pub. Date: Mar. 11, 2004

(54) System and method for exploring mining spaces with multiple attributes

(75) Inventors: Joseph L. Hellerstein, Ossining, NY (US); Sheng Ma, Briarcliff Manor, NY (US); Chang-Shing Perng, Bedford Hills, NY (US); Haixun Wang, Tarrytown, NY (US)

Correspondence Address: Ryan, Mason & Lewis, LLP, Suite 205, 1300 Post Road, Fairfield, CT, 06430, US

(73) Assignee: International Business Machines Corporation, Armonk, NY

(21) Appl. No.: 10/236,594

(22) Filed: Sep. 6, 2002

(51) Int. Cl. G06F 17/30; G06F 7/00

(52) U.S. Cl. 707/5

(57) ABSTRACT

Data with multiple attributes are separated into groups by performing at least the following steps for each group to be defined: (1) selecting a first subset of the attributes to be first attributes; and (2) selecting a second subset of the attributes to be second attributes. Patterns that occur a predetermined number of times in the data are determined by using the groups. A third part of a definition for a group includes the number of records having the group and item attributes. Groups are sorted into levels and each group has a number of predecessor relationships and a number of successor relationships with other groups. The groups then provide a mining space describing the data, and the groups are termed “mining camps.” The mining camps are searched for patterns that occur a predetermined number of times. The searching determines predecessor relationships and uses the predecessor relationships to speed processing.

### FIELD OF THE INVENTION

The present invention generally relates to data exploration and analysis techniques and, in particular, to systems and methods for finding frequent item sets from data with multiple attributes.

### BACKGROUND OF THE INVENTION

Mining for frequent item sets has been studied extensively because of the potential for actionable insights. This type of mining can determine, for instance, whether a shopper is likely to buy two items, such as baby diapers and baby shampoo, at the same time. The frequent item set is baby diapers and baby shampoo.

Typically, mining involves a preprocessing step in which data are grouped into transactions and items are defined based on attributes. For example, in supermarket data, data are grouped into transactions and the product-type attribute (with values such as diapers, beer, and napkins) is used to define items.

For data that can easily be processed into transactions, conventional mining techniques are suitable. However, when a “transaction” is hard to define, then conventional mining techniques typically fail.

Thus, what is needed are techniques for mining data that overcome drawbacks to conventional mining techniques requiring transactions.

### SUMMARY OF THE INVENTION

The present invention overcomes the limitations of the prior art by providing techniques for grouping data with multiple attributes and then efficiently searching the groups to determine frequent patterns in the data.

In one aspect of the invention, the data are defined into groups by performing at least the following steps for each group to be defined: (1) selecting a first subset of the attributes to be first attributes; and (2) selecting a second subset of the attributes to be second attributes. Then, patterns that occur a predetermined number of times in the data are determined by using the groups. Beneficially, the first attributes are termed grouping attributes and the second attributes are termed item attributes. It is beneficial that the subsets of grouping and item attributes are distinct. Thus, a definition of a group advantageously includes both grouping and item attributes. Additionally, a third part of a definition for a group generally includes the number of records having the group and item attributes. Advantageously, groups are sorted into levels and each group has a number of predecessor relationships and a number of successor relationships with other groups. The groups then provide a mining space describing the data. The groups are termed “mining camps” herein.

In a second aspect of the invention, the groups are searched in order to find frequent patterns. It should be noted that there could be no frequent patterns found. Each group has a certain number of candidate patterns defined by the group. These candidate patterns are created while searching for frequent patterns. During searching, the predecessor relationships for a mining camp are used to determine which techniques for creating candidate patterns for the mining camp are to be used. A predecessor relationship indicates a change in the number of records, grouping attributes, or item attributes from a predecessor group to a current group. By preferentially choosing, based on the predecessor relationships, how to create candidate patterns, candidate pattern generation of the present invention is significantly faster than conventional techniques. For instance, when a current group has a predecessor relationship due to a change in grouping attributes, using candidate generation based on the change in grouping attributes is faster than using candidate generation based on a change in number of records or item attributes. Because the speed of candidate pattern generation is improved, the speed of determining frequent patterns is also improved.

In a third aspect of the invention, taxonomies or functional dependencies are provided, and aspects of the present invention use the taxonomies or functional dependencies to further improve the speed of pattern generation and the determination of frequent patterns.

Benefits of the present invention include, but are not limited to, the following: (1) it is possible to mine multiple-attribute data without prespecifying the attributes used to group records into transactions or the attributes used to define items; (2) the concept of a mining camp, which beneficially has the three components of pattern length (e.g., the number of items having particular attributes defining items), the set of attributes used to group data into transactions, and the set of attributes used to define items, makes definition and searching of a mining space relatively simple; and (3) the use of two new kinds of downward closure related to searching mining camps for patterns means that the time to determine frequent patterns increases with increasing attributes, but the increase is not exponential relative to the number of attributes.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a table demonstrating data divided into transactions and items;

FIG. 2 is a table illustrating data having multiple attributes, where dividing data into transactions yields inefficient searching times and potentially erroneous results;

FIG. 3 is a block diagram of a data mining system in accordance with one embodiment of the present invention;

FIG. 4 is a diagram of one potential sorting technique for a mining space defined by mining camps;

FIG. 5 is a block diagram of a method for mining data using the mining space of FIG. 4;

FIG. 6 is a diagram of a preferred sorting technique for a mining space defined by mining camps, in accordance with one embodiment of the present invention;

FIG. 7 is a flowchart of a method for mining the mining space of FIG. 6, in accordance with one embodiment of the present invention;

FIG. 8 is a flowchart of a method for candidate generation, in accordance with one embodiment of the present invention;

FIG. 9 is an example of a predefined taxonomy, which the present invention can use to further increase speed when searching for patterns, in accordance with one embodiment of the present invention;

FIGS. 10 and 11 are examples of data structures suitable for use with the present invention, in accordance with one embodiment of the present invention; and

FIGS. 12, 13, 14, 15A, 15B, 16, 17, and 18 are exemplary pseudocode definitions of methods suitable for implementing aspects of the present invention, in accordance with one embodiment of the present invention.

### DETAILED DESCRIPTION OF PREFERRED EMBODIMENTS

To aid understanding, the following detailed description is organized into sections as follows: (1) the Introduction section, which provides examples to illustrate the multiple-attribute mining problem; (2) the FARM (FrAmework for exploRing Mining spaces) section, which describes exemplary methods and apparatus for mining spaces with multiple attributes; (3) the Downward Closure Properties section, which describes downward closure; and (4) the Exemplary Method and Implementation section, which provides an exemplary method, exemplary data structures, and exemplary pseudocode suitable for implementing aspects of the present invention.

### Introduction

The present invention improves upon conventional mining techniques by creating a mining space via mining camps. The mining camps define groups of data having multiple attributes. The mining camps generally comprise the number of patterns having certain grouping attributes and certain item attributes. An example of a mining camp would be (3,{A,B},{C,D}), where 3 indicates the number of patterns in a group defined by the attributes {A,B} that have attributes {C,D}, the attributes {A,B} are grouping attributes, and the attributes {C,D} are item attributes. The grouping attributes effectively act like a conventional “transaction.”

Each mining camp has predecessor/successor relationships with one or more other mining camps. The relationships are determined through levels and through “types.” For instance, a relationship between one mining camp and another can be determined by changing the number of patterns between camps (called “Type-1”), the number of grouping attributes (called “Type-2”), or the number of item attributes (called “Type-3”). Levels are determined via combinations of the number of patterns, grouping attributes, and item attributes. The mining camps and their relationships determine the mining space.

The mining space is searched for patterns that meet predetermined thresholds, which are generally supplied by the person using the present invention. An exemplary method for searching the mining space first generates the mining camps for a level, then generates candidate patterns for each mining camp, computes support for each candidate pattern, then eliminates candidates with low support. Beneficially, the generation of candidate patterns is performed to reduce computational complexity and time. While the initial candidate set can be generated from the pattern sets of any of type of predecessors, in general, the most efficient candidate generation is to start from patterns of Type-2 predecessors. This “Type-2 candidate generation” is performed by taking intersections, a computation that can be done in linear time (if patterns are sorted). In contrast, both Type-1 and Type-3 candidate generations require a “join” operation. Not only is this more computationally intensive, the number of candidates generated tends to be very large. The method of the present invention tries to generate candidates from the pattern sets of its Type-2 predecessors and then uses pattern sets of other types to further filter candidates. If there is no Type-2 predecessor, the Type-1 predecessor is used instead. If there is no Type-1 predecessor, Type-3 predecessors are used.

When the mining space is searched, an “aggregating” function is generally used to determine which pattern instances comprise a pattern. For instance, if a mining camp with two items contains “a,a,b,b,b.” Then, it is necessary to decide how many <a,b> pattern instances there are. If one chooses an existence function as the aggregating function, then there is only one pattern instance of <a,b> as defined by the existence function. If one chooses a minimum function, then minimum(2,3) is two pattern instances of <a,b> as defined by the minimum. A user can decide what kind of counting he or she would like to use.

Thus, aspects of the present invention exploit relationships in mining spaces to reduce computational complexity and time. Further decreases in complexity and time may be achieved when taxonomies or other functional dependencies are exploited.

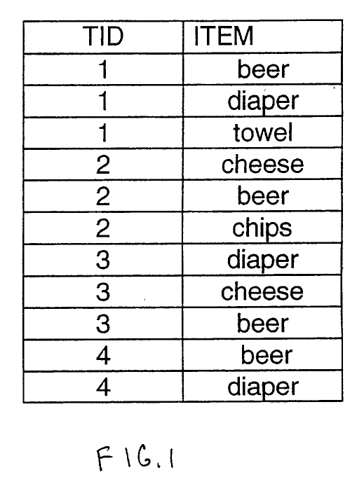

Turning now to FIG. 1, a simple table is shown where data has been grouped into transactions, by Transaction IDentifications (TIDs), and items. Typically, conventional mining techniques involve a preprocessing step in which data with multiple attributes are grouped into transactions and items are defined based on attribute values. For example in supermarket data such as shown in FIG. 1, the market basket attribute might be used to group data into transactions and the product-type attribute (with values such as diapers, beer) to define items.

It can be observed that fixing the attributes used to define transactions and items can severely constrain the patterns that are discovered. For example, by having items characterized in terms of product type, conventional mining techniques may fail to discover relationships between baby items in general (e.g., diapers, formula, and rattles) and adult beverages (e.g., beer and wine). And, by having transactions be market baskets, conventional mining techniques may fail to note relationships between items purchased by the same family in a single day.

To go beyond the limits of fixed attribute mining, the present invention introduce a new mining framework that uses mining spaces to discover frequent patterns for transactions and items that are defined in terms of data attributes. Here a “transaction” is a general term for a group of records. The present invention and its framework does not require prespecified taxonomies, although the present invention exploits such information if it is available. The present invention also provides downward closure holds for a class of mining spaces. This result provides for the implementation of efficient mining algorithms even when the mining spaces themselves are used. Using the present invention, it is possible to determine that beer and diapers are associated with each other in the data shown in FIG. 1. In other words, people who buy diapers generally buy beer at the same time. Thus, beer and diapers are one frequent item set that conventional mining techniques may not find or may find after a much larger amount of processing, as compared to the present invention.

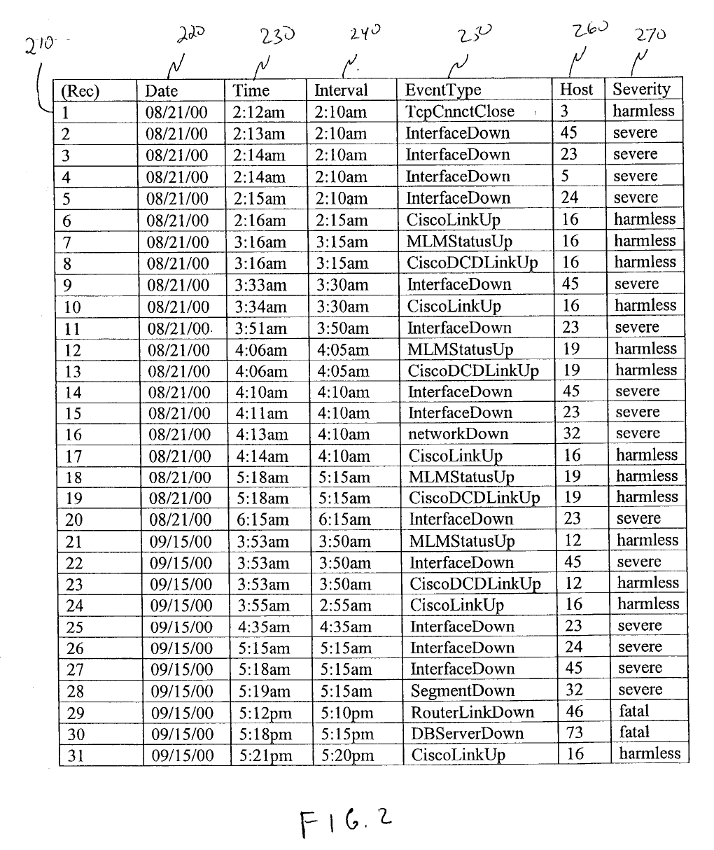

FIG. 2 is an example of multiple-attribute records where data mining is much more complex than for the data illustrated in FIG. 1. FIG. 2 illustrates a table of system management events comprising records, of which record 210 is marked. FIG. 2 illustrates event data obtained from a production network at a large financial institution. These system management events are associated with components in a distributed computing system. Events are messages that are generated when a special condition arises. The relationship between events often provides actionable insights into the cause of existing network problems as well as advanced warnings of future problem occurrences. The attributes of the data are as follows: Date 220, Time 230, Interval 240 (e.g., a five minute interval), EventType 250, Host 260 from which the event originated, and Severity 270. The column labeled (Rec) is only present to aid in making references to the data. There is no apparent “transaction ID” and “item” that can be used for traditional frequent item set mining so there is no straightforward way to apply a priori-like method to find associations.

It is possible to observe the following:

(1) Host 23 generated a large number of InterfaceDown events on August 21. Such situations may indicate a problem with that host.

(2) When Host 45 generates an InterfaceDown event, Host 16 generates a CiscoLinkUp (failure recovery) event within the same five minute interval. Thus, a Host 45 InterfaceDown event may provide a way to anticipate the failure of Host 16.

(3) The event types MLMStatusUp and CiscoDCDLinkUp tend to be generated from same Host and within the same minute. This means that when a Cisco router recovers a link, it will discover that its mid-level manager is accessible. Such event pairs should be filtered since they arise from normal operation.

(4) Host 24 and Host 32 tend to generate events with same severity in the same day. This suggests a close linkage between these hosts. If this linkage is unexpected, it should be investigated to avoid having problems with one host cause problems with the other host.

Several definitions of transactions and items are needed to discover patterns (1)-(4). For pattern (2), transactions are determined by groupings events into five minute intervals (attribute Interval 240). For patterns (1) and (4), event groupings are done by Date 220 attribute. For pattern (3), a transaction is events that occur on the same Host 260 within the same minute. The definition of items is similarly diverse. For patterns (1) and (4), an item is a Host 260. For pattern (3), it is an EventType 250. For pattern (2), it is determined by the values of Host 260 and EventType 250.

Herein, the mining problem is extended to include the manner in which data attributes are used to define transactions and items. One way to approach this extended data mining problem is to iteratively preprocess the data to form different items and transaction groupings and then apply current mining algorithms. However, this scales poorly. For example, for a data set with six attributes, it turns out that there are 665 ways to group and label records. Another approach is to mine for multi-level associations. Unfortunately, this requires specifying hierarchies. Since many such hierarchies are possible, considerable iteration may be necessary. Further, these approaches do not address how to group data into transactions.

Some conventional data mining techniques have identified an association rule problem and developed a level-wise search method. Other conventional techniques consider multi-level association rules based on item taxonomies. Still other techniques provide further extensions to handle more general constraints. All of these efforts assume that items occupy a fixed position in the hierarchy and that the hierarchies are known in advance. Further, none of these considers different ways of grouping records into transactions. In contrast, the present invention enables the discovery of patterns without either fixing the way in which transactions are defined or prespecifying an item hierarchy.

Additional conventional techniques extend metaqueries to relational databases and multi-dimensional data cubes. Meta-rules can be viewed as rule templates expressed as a conjunction of predicates instantiated on a single record. In contrast, the present invention considers multiple-attribute patterns formed from multiple records. Further, the present invention mines the transaction groupings as well, something that the foregoing work does not address.

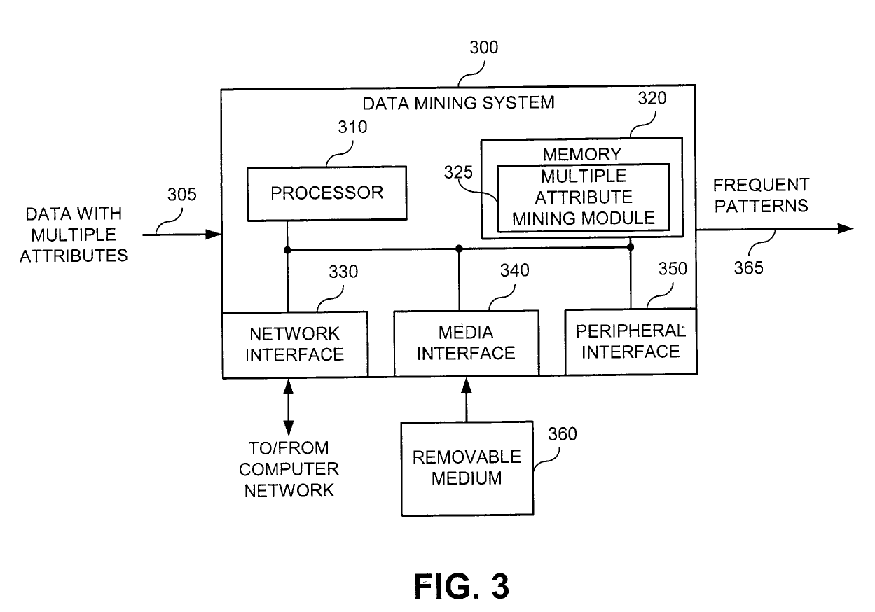

Referring now to FIG. 3, an exemplary data mining system 300 is shown accepting data with multiple attributes 305 and determining frequent patterns, represented in FIG. 3 as being placed on output 365. Data mining system 300 comprises a processor 310, a memory 320, a network interface 330, a media interface 340, and a peripheral interface 350. Peripheral interface 350 is shown, in this example, coupled to a removable medium 360. Memory 320 comprises a Multiple Attribute Mining (MAM) module 325. The MAM module 325 implements methods of the present invention in order to mine the data with multiple attributes 305 and determine frequent patterns 365. When the data mining system 300 is processing data, portions of the MAM module 325 are loaded into processor 310 for execution.

The processor 310 can be distributed or singular, and the memory 320 can be distributed or singular. Additionally, elements of the data mining system 300 can be coded into a microprocessor or a gate array or other suitable hardware modules. Network interface 330 operates to connect the data mining system 300 with a network, such as a wired or wireless network. Media interface 340 operates with long term memory, such as hard drives, Read Only Memory (ROM), and other readable, write-able, or both memories. For instance, media interface 340 can couple the data mining system 300 to removable medium 360, such as removable compact disk or magnetic media. The memory 320 and removable medium 360 are suitable to enable the data mining system 300 to perform the techniques of the present invention. The removable medium 360 is an example of an article of manufacture. It should also be noted that portions or all of the MAM module 325 may be accessed by or through the network interface 330. The memory 320 may comprise the data with multiple attributes 305 and the frequent patterns 365, if desired. It should be noted that the MAM module 325 may determine that no frequent patterns are in the data with multiple attributes 305. In this situation, generally the output 365 will report this condition. For instance, a “No Frequent Patterns” message could be output via output 365 when no frequent patterns are found.

### The FARM System

This section describes the elements of the FARM system, implemented by the MAM module 325, for mining data with multiple attributes. The FARM framework goes beyond fixed attribute mining to mine directly from multiple-attribute data. Data D is provided with attributes A={A₁, . . . , Aₖ}. Thus, each record in D is a k-tuple. For a given pattern, a subset of these attributes is used to define how transactions are grouped and another disjoint subset of attributes determines the items. The former are called the grouping attributes, and the latter are the itemizing attributes.

It is worthwhile to describe these concepts through an example. Consider an example based on the table shown in FIG. 2. Here, k=6. For pattern (3), described above, the grouping attributes are Host 260 and Time 230; the itemizing attribute is EventType 250. The pattern has length two, which means that a pattern instance has two records. The items specified by these records are determined by the value of the EventType 250 attribute. That is, one record must have EventType=MLMStatusUp and the other has EventType=CiscoDCDLinkUp. Further, these records must have the same value for their Host 260 and Time 230 attributes. Records 7 and 8 form an instance of pattern (3) with Host=16 and Time=3:16 am. Note that items may be formed from multiple attributes. For example, pattern (2), described above, has the itemizing attributes Host 260 and EventType 250.

The term “mining camp” is used to provide the context in which patterns are discovered. A mining camp acts to group data by defining a subset of the data. Context includes pattern length, grouping attributes, and itemizing attributes. For example, pattern (3) has the mining camp (2; {Host; Time}, {EventType}).

Definition 1. A mining camp is a triple (n, G, S) where n is number of records in a pattern, G is a set of grouping attributes, and S is the set of itemizing attributes. A mining camp is well formed if G∩S={ }. A mining camp is minable if S≠{ }.

It is beneficial that G∩S={ } to avoid interactions between the manner in which groupings are done and items are defined. It is also beneficial that S≠{ } since there should be items to count (even if there is only one group).

Next, the notion of a pattern is formalized. There are several parts to this. First, note that two records occur in the same grouping if their G attributes have the same value. Let r∈D. The notation π_{G}(r) is used to indicate the values of r that correspond to the attributes of G.

Definition 2. Given a set of attributes G, two records r₁ and r₂ are G-equivalent if and only if π_{G}(r₁)=π_{G}(r₂).

In the table shown in FIG. 2, records 7 and 8 are G equivalent, where G={Host, Time}.

In the present invention, items are determined by the combinations of values of the attributes of S. Consider pattern (2) for which the following are required: one record with EventType=InterfaceDown, Host=45 and a second for which EventType=CiscoLinkUp, Host=16. Thus, (InterfaceDown, 45) is one component (or item) of the pattern and (CiscoLinkUp, 16) is the other component.

Definition 3. Given a mining camp (n, G, S) where S={S₁, . . . Sₘ}. A pattern component or item is a sequence of attribute values sν=<s₁, . . . sₘ> where sₜ∈Sₜ for 1≦i≦m. p= [symbol] sνₗ, . . . , sνₙ [symbol] is a pattern of length n for this mining camp if each svₜ is a pattern component for S.

An instance of a pattern is a set of records that are in the same grouping and whose itemizing attributes match those in the pattern.

Definition 4. Let p= [symbol] sν₁, . . . , sνₙ [symbol] be a pattern in mining camp (n, G, S) and let D be a set of records. An instance of pattern p is a set of n records R={r₁, . . . , rₙ} such that rₗ∈D and π_{S}(rₗ)=sνᵢ for 1≦i≦n, and rₗ and rⱼ are G-equivalent for all r₁, r₂∈R.

Having defined what is meant by an item, a pattern, and a pattern instance, consider now the support for a pattern. A G-equivalent class may have a large number of records. A decision has to be made about whether multiple instances in a G-equivalent class should provide more support than one instance. Conventional techniques assume at most one pattern instance can be found in one transaction. It is believed that this decision is domain dependent. So, this decision is isolated to the choice of an aggregating function,ƒ: Z⁺→Z⁺. Two common choices off are the following:

$$( 1 ) Existence Function : \qquad f ( x ) = \{ \begin{matrix}1 & if x = 0 \\ 0 & otherwise\end{matrix} \} , or$$

(2) Identity Function: ƒ(x)=x.

Now the concept of support is defined in the FARM framework.

Definition 5. Given an aggregating function ƒ, a mining camp (n, G, S) and a set of records D that can be divided to G-equivalent classes GEC₁, . . . GEC_{w}, the ƒ-support of a pattern p is defined as ƒ(|GEC₁|ₚ)+ . . . +ƒ(|GEC_{w}|ₚ) where |GECᵢ|ₚ is the number of disjoint instances of p in GECᵢ for 1≦i≦w.

Now, all of the definitions necessary to discuss mining in the FARM framework have been described. First, note that if G and S are fixed, then a traditional fixed attribute data mining problem results. In conventional techniques, downward closure of the pattern length is used to look for those patterns in (n+1, G, S) for which there is sufficient support in (n, G, S).

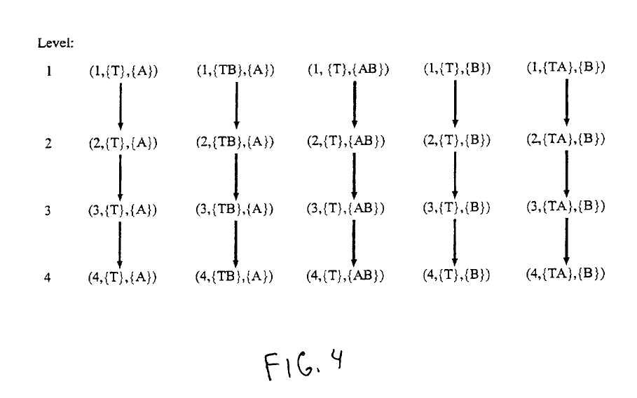

In the present invention, G and S need not be fixed. Consider the attributes T, A, B for which it is required that T∈G. FIG. 4 displays one possible way to search these mining camps. In essence, a separate search is done for each combination of G and S over the various levels, each level defined an increase in the number of patterns required.

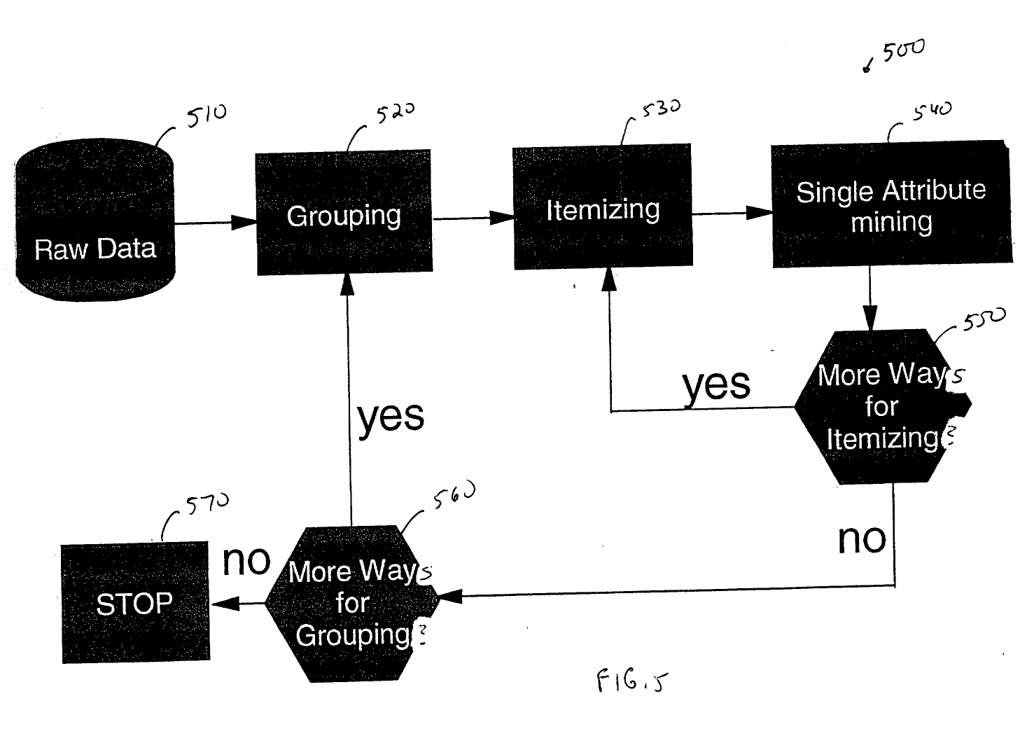

A diagram for one possible method 500 that uses the mining space of FIG. 4 is shown in FIG. 5. Raw data 510 is grouped in step 520. The data are then itemized in step 530, then single-attribute mining is performed in step 540. If there are more ways for itemizing (step 550=YES), the method 500 continues again at step 530. If there are no more ways to itemize (step 550=NO), the method continues in step 560. If there are more ways for grouping (step 560=YES), the method continues in step 520. If there are no more ways to group the data (step 560=NO), then the method 500 ends in step 570.

A significant detriment to this possible technique is that it scales poorly. In particular, the number of permitted combinations of G and S is 3^{k}−2^{k} where k is the number of attributes. Consequently, for the data of FIG. 2, there are 3⁶−2⁶=665 combinations. FIG. 2 is a relatively simple example, yet requires quite a few permitted combinations.

The present invention reduces the total number of combinations by eliminating candidate patterns on a mining camp basis. Additionally, the mining camps are structured to have relationships between each other. It is beneficial to examine the technique for searching mining camps through some examples from the table shown in FIG. 2. Let G={Date}, which results in two groups: records 1-20 and 21-31. Now consider G′=G∪{Interval}. This new set of grouping attributes redefines the previous groupings. Thus, if records are not in the same {Date} grouping, then they cannot be in the same {Date, Interval} grouping. Hence, patterns based on these records cannot have more instances in {Date,Interval} than they do in {Date}.

Similarly, consider Aₗ∉S. Let p be a pattern in (n, G, S). Now consider (n+1, G, S∪{A₃}). If p is a sub-pattern of p₀ in this second mining camp, then every occurrence of p₀ in this camp is also an occurrence of p in the r-st camp.

The foregoing suggests that mining camps can be ordered in a way that relates to downward closure.

Definition 6. Given a mining camp c=(n, G, S) and an attributedAᵢ∉G∪S then

(1) (n+1, G, S) is the Type-1 successor of c.

(2) (n, G∪Aₗ, S) is the Type-2 successor of c.

(3) (n, G, S∪Aₗ) is the Type-3 successor of c.

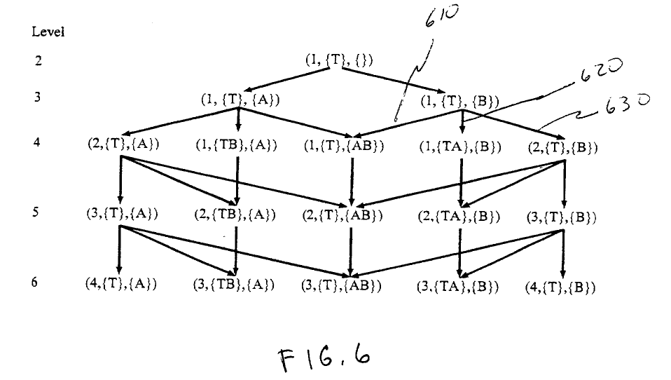

Thus, a Type-1 successor indicates an increase in the number of patterns, a Type-2 successor indicates an increase in the grouping attributes, and a Type-3 successor indicates an increase in the item attributes. FIG. 6 depicts predecessor/successor relationships for a mining space using techniques of the present invention. The root precedes all other mining camps. In this case, it is not a real mining camp since S={ }. The level of mining camp (n, G, S) is defined as n+|G|+|S|. Since n is at least 1 and S is nonempty, a minable mining camp has level no less than 2. The mining camps are structured so that the successor relationships only exist between mining camps at different levels. This imposes a partial order.

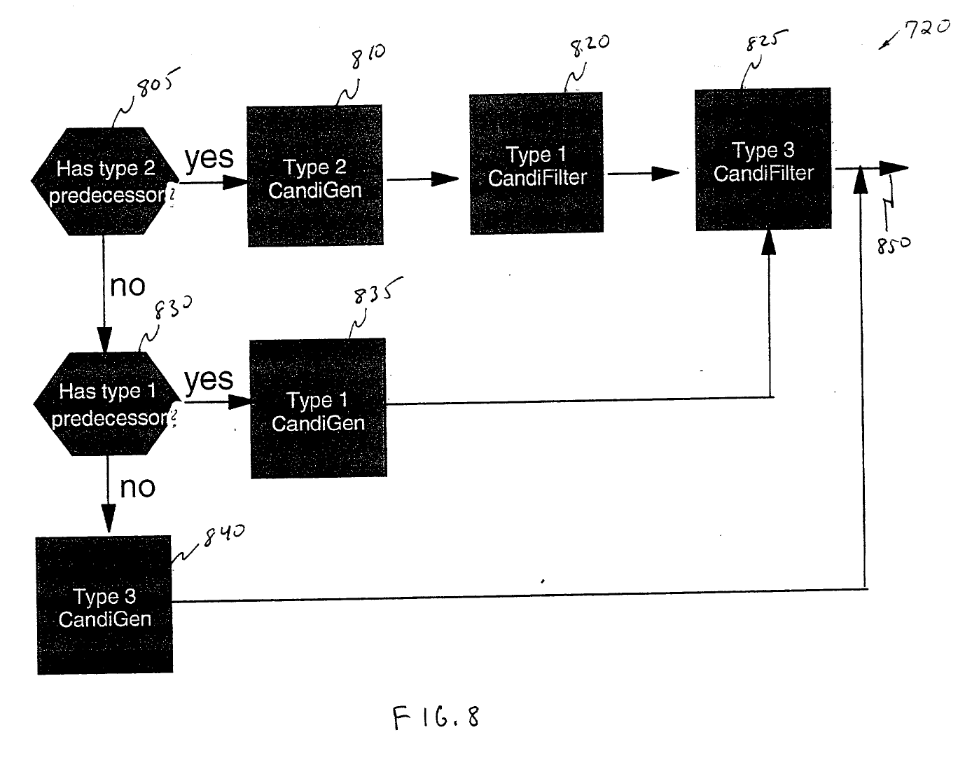

FIG. 6 is an example of such a mining space. In FIG. 6, the predecessor/successor relationships are indicated as arrows. For instance, arrow 610 indicates an increase in an item attribute; arrow 620 indicates an increase in the grouping attribute; and arrow 630 indicated an increase in the number of patterns. These relationships are advantageously used to reduce search time. This is described in more detail in reference to FIG. 8. Another technique to reduce search time involves determining if the criteria of a mining camp are met. For example, if the mining camp of (1, {TB}, {A}) is not met (e.g., meaning that there is no single instance of a pattern having TB as a grouping attribute and A as an item attribute), then (2, {TB}, {A}) and (3, {TB}, {A}) will also not be met and need not be performed. However, the ability to quickly determine that (1, {TB}, {A}) is not met is what is important and is what the present invention achieves.

The definition of a mining space is given formally below.

Definition 7. A mining space, MS(c) is a partially ordered set (poset) of mining camps containing c and all of its successors.

To make the notation more readable, the notation MS(n, G, S) to denote MS((n, G, S)).

Definition 8. A FARM problem is a triple (MS(c),ƒ, minsup) where ƒ is an aggregating function and minsup is minimum support threshold. The solution of a FARM problem in dataset D is all patterns of every mining camp in MS(c) with ƒ-support greater than minsup.

One concern with this problem formulation is the potential for an explosive growth in the number of mining camps as the number of attributes increases. Many of these mining camps may contain meaningless combinations of itemizing and/or grouping attributes. This problem can be addressed, in part, by employing a rule-based mechanism that allows domain experts to specify the part of the mining space that may contain interesting patterns. In particular, such user-defined directives could be expressed as predicates on the elements in G and S, such as which attributes can be members of which set and under what conditions (e.g., always, never, only if another attribute is not present). It should be noted, however, that removing some mining camps from a mining space does not necessarily guarantee faster execution because the results of removed mining camps may be used to reduce the number of candidates of the next level.

### Downward Closure Properties

This section shows that several types of downward closure can be present in the FARM framework. Exploiting these properties provides considerable benefit in terms of efficiency. This section begins by defining properties of the aggregating function.

Definition 9. Assume ƒ is an aggregating function, then

(1) ƒ is Type-1 downward closed if ƒ is non-decreasing.

(2) ƒ is Type-2 downward closed if ƒ is monotonic increasing and for any two G-equivalent classes GEC₁ and GEC₂, and a given pattern p, ƒ(|GEC₁|ₚ)+ƒ(|GEC₂|ₚ)≦ƒ(|GEC₁∪GEC₂|ₚ).

(3) ƒ is Type-3 downward closed if ƒ is non-decreasing.

Note that by this definition, ƒ is Type-1 downward closed if and only if ƒ is Type-3 downward closed.

Thus, a main result is that downward closure is possible for n, G, and S.

Given a mining camp c=(n, G, S) and an aggregating function ƒ such that the ƒ-support of a pattern p={sν₁, . . . , sνₙ} is less than minsup, the following can be proven:

(1) If ƒ is Type-1 downward closed then for any Type-1 successor of c, any pattern that is a superset of p has ƒ-support less than minsup.

(2) If ƒ is Type-2 downward closed then the ƒ-support of p in any of Type-2 successor of c is less than minsup.

(3) If ƒ is Type-3 downward closed then the ƒ-support of pattern p={sν′₁ , . . . , sνₙ } of any Type-3 successor of c is less then minsup if sνₗ◖sνᵢ⁴⁰ for 1≦i≦n.

This is proved in Perng et al., “FARM: A Framework for Exploring Mining Spaces with Multiple Attributes,” Proc. of the 2001 IEEE Int'l Conf. on Data Mining, 449-456 (November 2001), the disclosure of which is hereby incorporated by reference. Downward closure properties are the foundation of FARM as they are in traditional (fixed attribute) mining for frequent item sets. The more downward properties the chosen aggregating function has, the greater the efficiencies that can be realized in mining. Note that the identity function has all three downward closure properties. However, the existence function is Type-1 and Type-3 downward closed but not Type-2 downward closed.

### Exemplary Method and Implementation

This section describes an exemplary (MAM) method and implementation for mining FARM problems. MAM exploits the downward closure properties stated above to improve the efficiency of mining.

The extended mining problem addressed herein raises some difficult scaling issues as a result of discovering mining camps with different grouping attributes G. Existing mining algorithms assume that data are sorted by transaction identifier so that locality can be exploited in counting pattern instances. Such locality can be imposed on FARM problems as well if there is an attribute T, called the ordering attribute such that: (1) T is required to be in G, (2) data records are sorted by T, and (3) all of the records in a T-equivalent class fit in main memory.

Possible ordering attributes include those that deal with time (e.g., day) and place (e.g., zip code). However, even if locality is not present, other techniques can be used to improve efficiency, such as decomposing the problem into subproblems with fewer attributes.

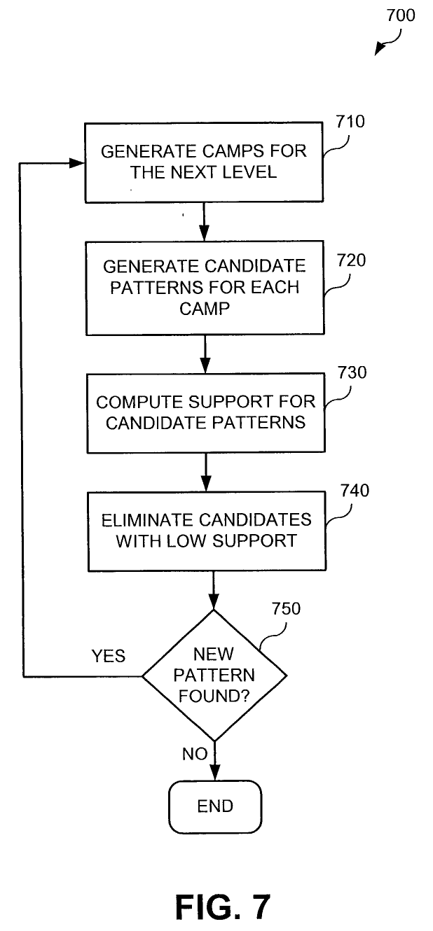

An exemplary MAM method 700 is shown in FIG. 7. Method 700 creates a mining space from data with multiple attributes and searches the mining space for frequent patterns. The end result of method 700 are those patterns meeting a predetermined threshold. Method 700 begins in step 710, when mining camps are generated for the next level. Generally, a mining spaces starts at a root node, as shown in FIG. 6. Once the mining camps for the next level are generated, then candidate patterns for each mining camp are generated in step 720. Step 720 is an important step, because the type of the predecessor relationship is used to reduce computation. This is described in more detail in reference to FIG. 8. In step 730, support is computed for candidate patterns. Those candidates with low support are eliminated in step 740. If any new pattern, meeting the predetermined threshold, is found (step 750=YES) steps 710 through 750 are performed again. If no new patterns are found (step 750=NO), the method ends.

Turning now to FIG. 8, a flow chart of an exemplary method 720 is shown for candidate generation. What method 720 does is employ selective candidate generation and filters, according to the downward closure properties stated above, to reduce processing time. Broadly, method 720 determines whether a mining camp has certain predecessor relationships then uses these predecessor relationships to advantageously reduce the number of steps required to create candidates. For instance, if a mining camp has a Type-2 predecessor, it is beneficial to generate candidates using a Type-2 generation technique.

As described above, the initial candidate set can be generated from the pattern sets of any of type of predecessors. But in general, the most efficient candidate generation is to start from patterns of Type-2 predecessors. This is because patterns of Type-2 predecessors have the same n and S as their successors. Thus, successor patterns are computed by refining the G-equivalent classes of the predecessor. This is done by taking intersections, a computation that can be done in linear time (if patterns are sorted). In contrast, both Type-1 and Type-3 require a “join” operation. Not only is this more computationally intensive, the number of candidates generated tends to be very large. The method 720 tries to generate candidates from the pattern sets of its Type-2 predecessors and then uses pattern sets of other types to further filter candidates. If there is no Type-2 predecessor, the Type-1 predecessor is used instead. If there is no Type-I predecessor, Type-3 predecessors are used.

Method 820 begins in step 805, when it is determined whether the selected mining camp has a Type-2 predecessor. If so (step 805=YES), then Type-2 candidate generation is performed in step 810. In step 820, a Type-1 candidate filter is performed, and step 825 performs a Type-3 candidate filter. The order between steps 820 and 825 is not important, although empirical studies suggest that executing a Type-1 candidate filter prior to a Type-3 candidate filter is slightly beneficial. When there is no Type-2 predecessor for the selected mining camp (step 805=NO), then it is determined if the selected mining camp has a Type-1 predecessor in step 830. If so (step 830=YES), a Type-1 candidate generation is performed in step 835. The method 800 continues in step 825. If not (step 830=NO), then a Type-3 candidate generation is performed in step 840. The output 850 is then a list of potential candidates.

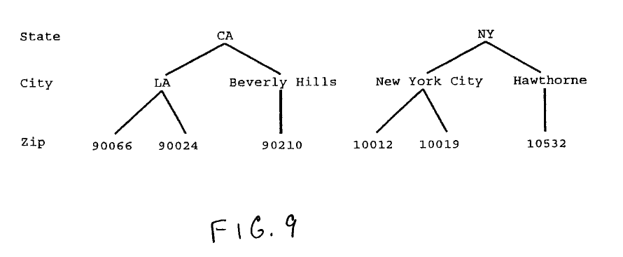

In some situations, taxonomies (is-a hierarchies) are available. For example, FIG. 9 shows a taxonomy of geographical information with three levels: (1) zip code; (2) city; and (3) state. A reasonable database design is to store only the lowest level attribute, e.g., zip code, in a main table, keep the taxonomies in a separate table, and create a logical view that contains all attributes for data mining.

Since the value of a lower level attribute uniquely determines the value of attributes at a higher level, taxonomies are special classes of functional dependencies. So, it is sufficient to discuss functional dependencies. Assuming that the values of an attribute set U uniquely determine the values of attribute set V, a functional dependency is denoted as U→V.

When there is a functional dependency, it is useful to exploit this dependency to avoid unnecessary computation. For instance, there is not a need to discover that “houses located in the same zip code tend to be in the same city,” as shown in FIG. 9. To avoid this unnecessary computation, the following can be proven:

Suppose U, V, G, and S are attribute sets and U uniquely determine V. Then:

(1) The output of (n, U∪V∪G, S) and (n, U∪G, S) are identical.

(2) The output of (n, G, S∪U∪V) can be derived from the output of (n, G, S∪U) by looking up the taxonomy.

(3) for n>1, (n, U∪G, V) has no pattern.

Using taxonomy information and the information given above, it can be shown that the number of mining camps that can be pruned at each level can be significant (see, for instance, FIG. 5 of Perng et al., already incorporated by reference above).

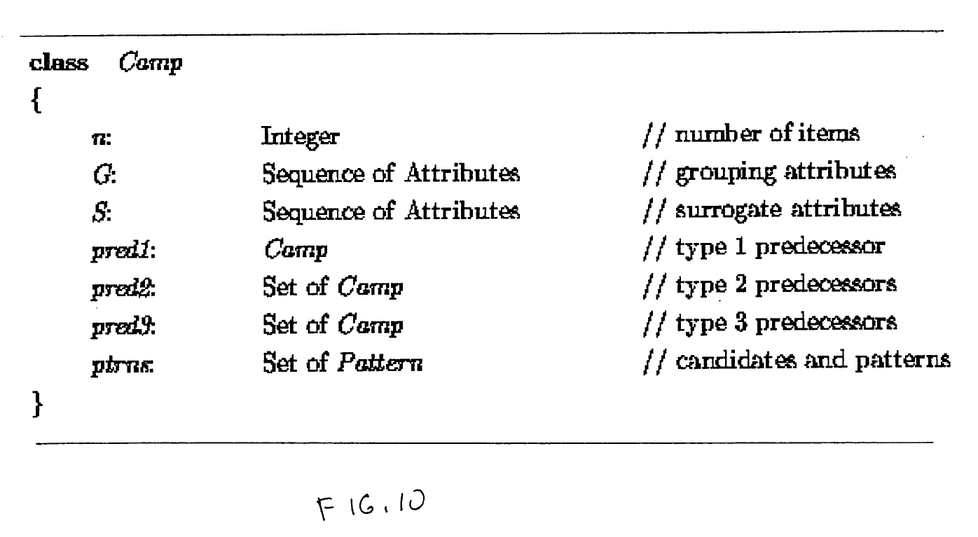

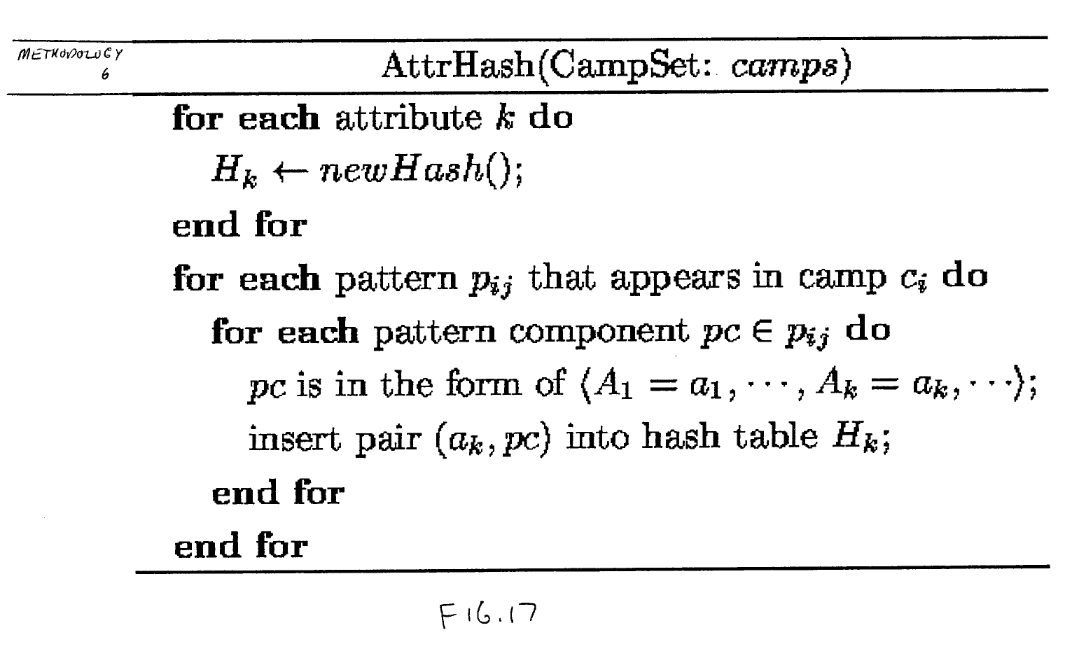

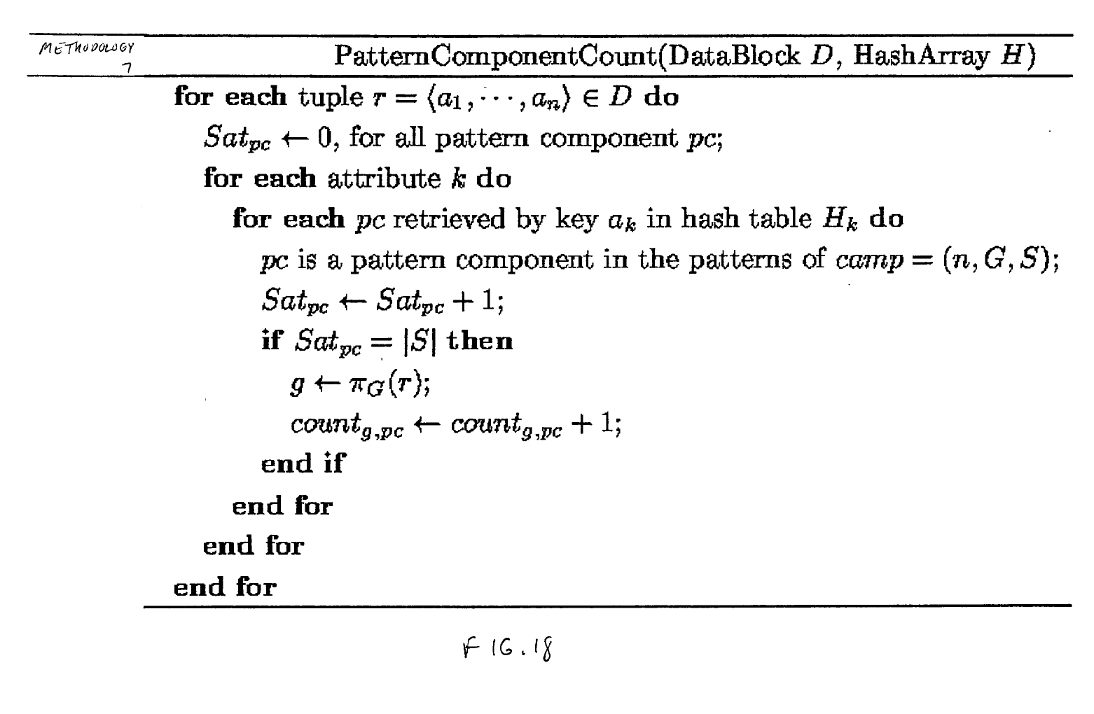

The rest of this disclosure describes an exemplary implementation of a MAM method, as shown in FIGS. 10 through 18. This implementation is described in an object-oriented fashion and in pseudocode. It is to be appreciated that the pseudocode shown is simply one possible illustrative implementation of the techniques of the present invention and is not intended to be limiting.

The core data structure is the Camp class shown in FIG. 10. The member patterns contain candidates before counting their ƒ-support has been computed, and it contains patterns after counting is completed and low-support candidates are removed.

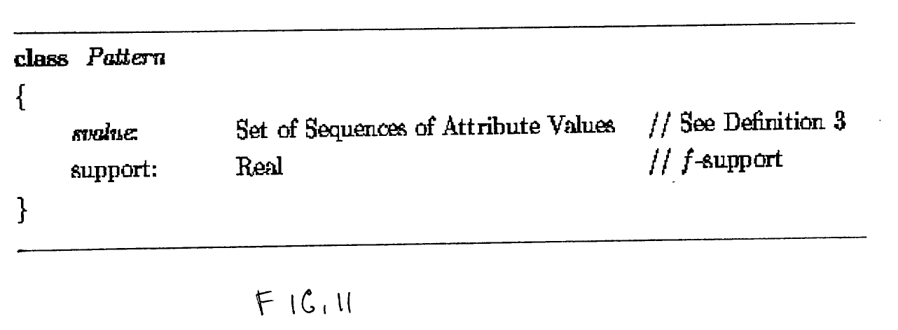

The Pattern class is defined in FIG. 11.

The MAM method adapts to the choice of the aggregating functions. If the aggregating function has all three downward closure properties, the mining space looks like FIG. 5 and the lowest level containing minable camps is level 3, e.g., (1,{T},{Aᵢ}). Otherwise, the mining space looks like FIG. 3 in which the level of a mining camp is defined as the number of items, n, in the camp.

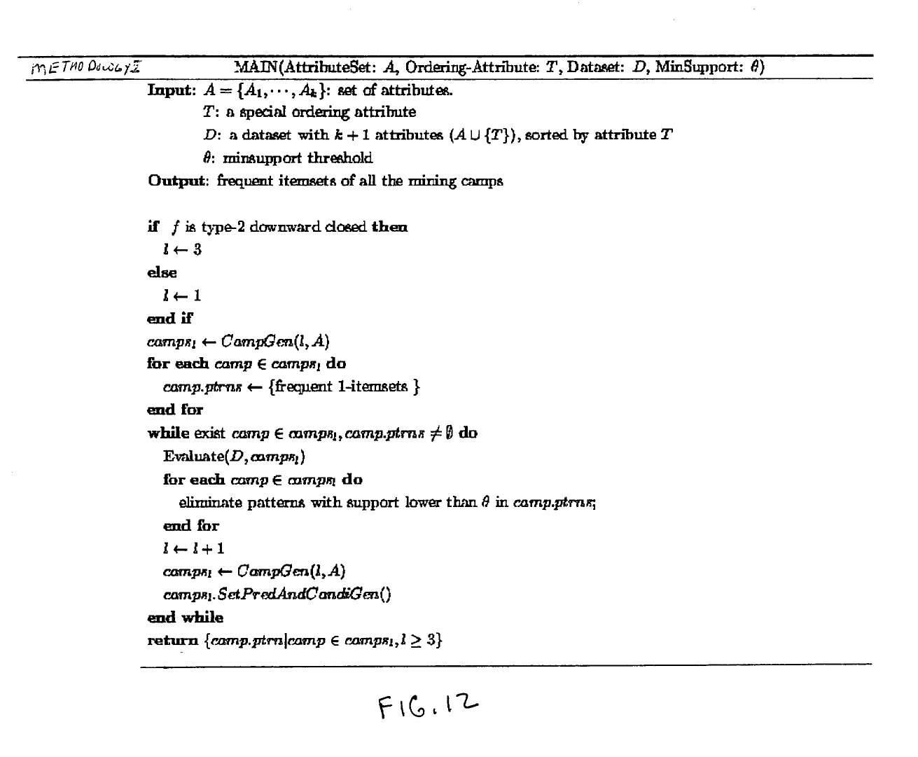

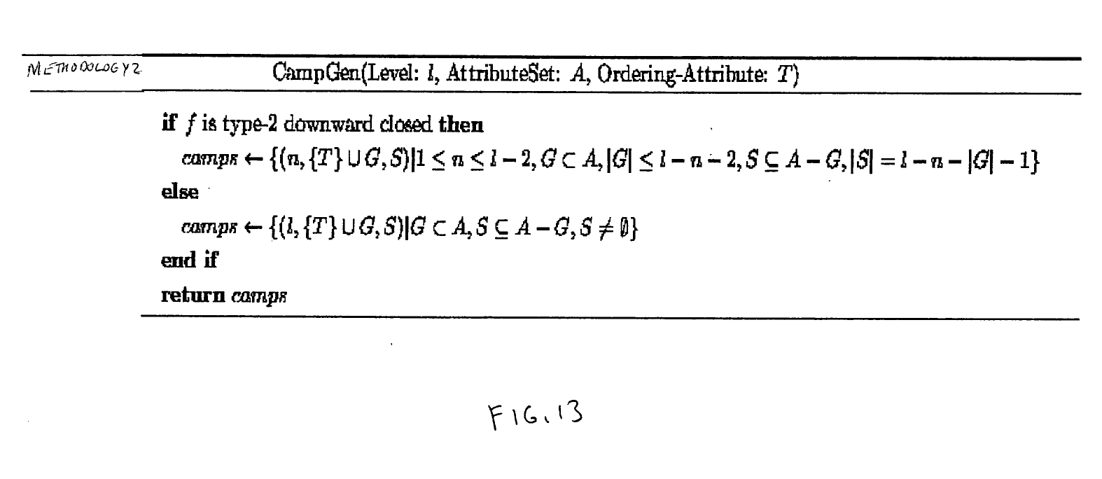

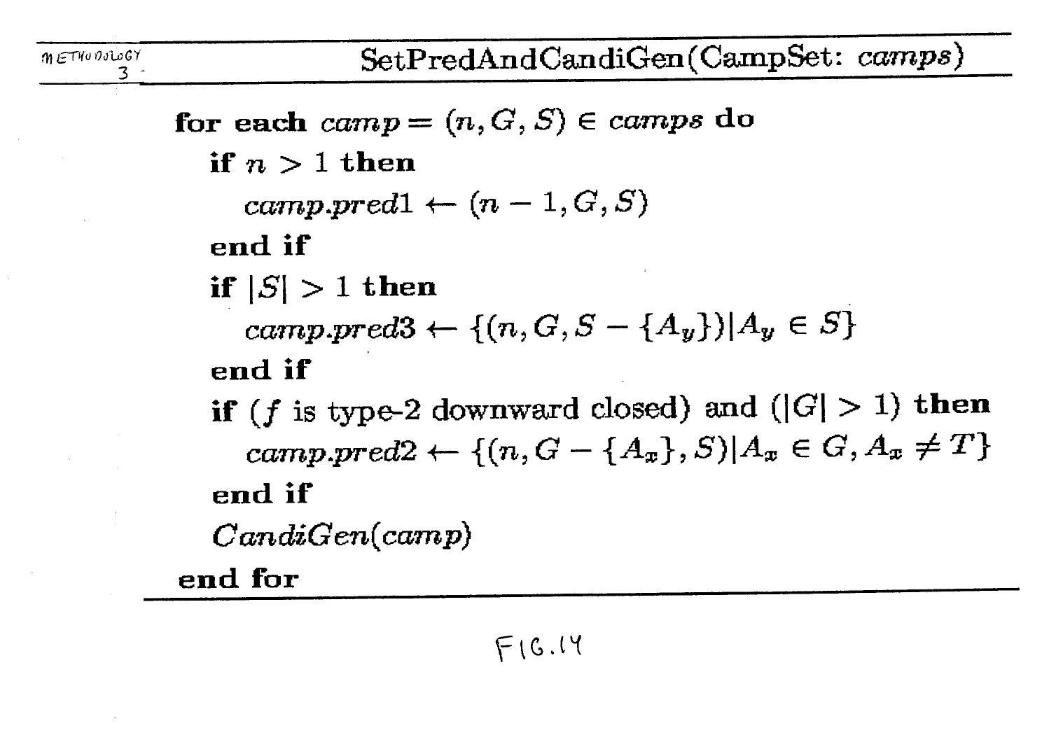

This exemplary MAM method is formed into seven routines. Methodology 1, the top level routine shown in FIG. 12, operates with certain characteristics of an apriori method. However, Methodology 1 sets levels based on the kinds of downward closure present, and the methodology operates on mining camps, not candidate patterns. Methodology 2, CampGen, is called by Methodology 1 to generate mining camps. Methodology 2 is shown in FIG. 13. Note that Type-2 downward closure is used to make camp generation more efficient. Methodology 3, SetPredAndCandiGen, determines the predecessor to use when extending the set of patterns. Type-2 downward closure is exploited here as well. Methodology 3 is shown in FIG. 14.

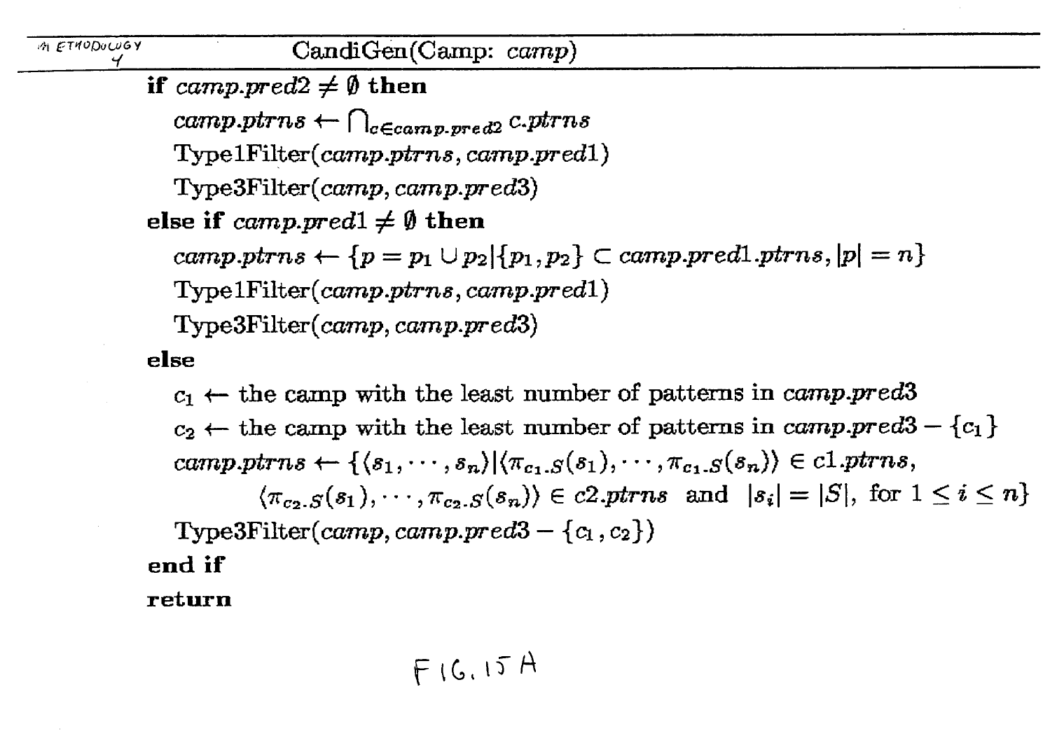

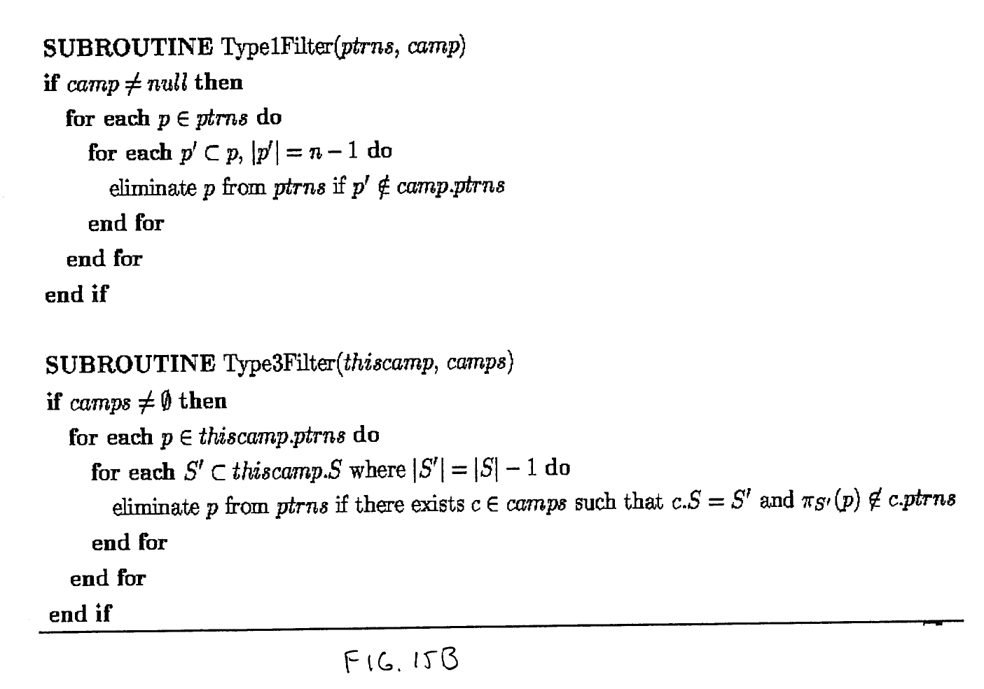

Methodology 4, CandiGen, applies the extended downward closure properties. Methodology 4 is shown in FIGS. 15A and 15B. There are two issues here: how to generate candidates and how to filter out impossible candidates. As described above, the initial candidate set can be generated from the pattern sets of any of type of predecessors. But in general, the most efficient candidate generation is to start from patterns of Type-2 predecessors. This is because patterns of Type-2 predecessors have the same n and S as their successors. Thus, successor patterns are computed by refining the G-equivalent classes of the predecessor. This is done by taking intersections, a computation that can be done in linear time (if patterns are sorted). In contrast, both Type-1 and Type-3 require a “join” operation. Not only is this more computationally intensive, the number of candidates generated tends to be very large. The methodology tries to generate candidates from the pattern sets of its Type-2 predecessors and then uses pattern sets of other types to further filter candidates. If there is no Type-2 predecessor, the Type-1 predecessor is used instead. If there is no Type-1 predecessor, Type-3 predecessors are used.

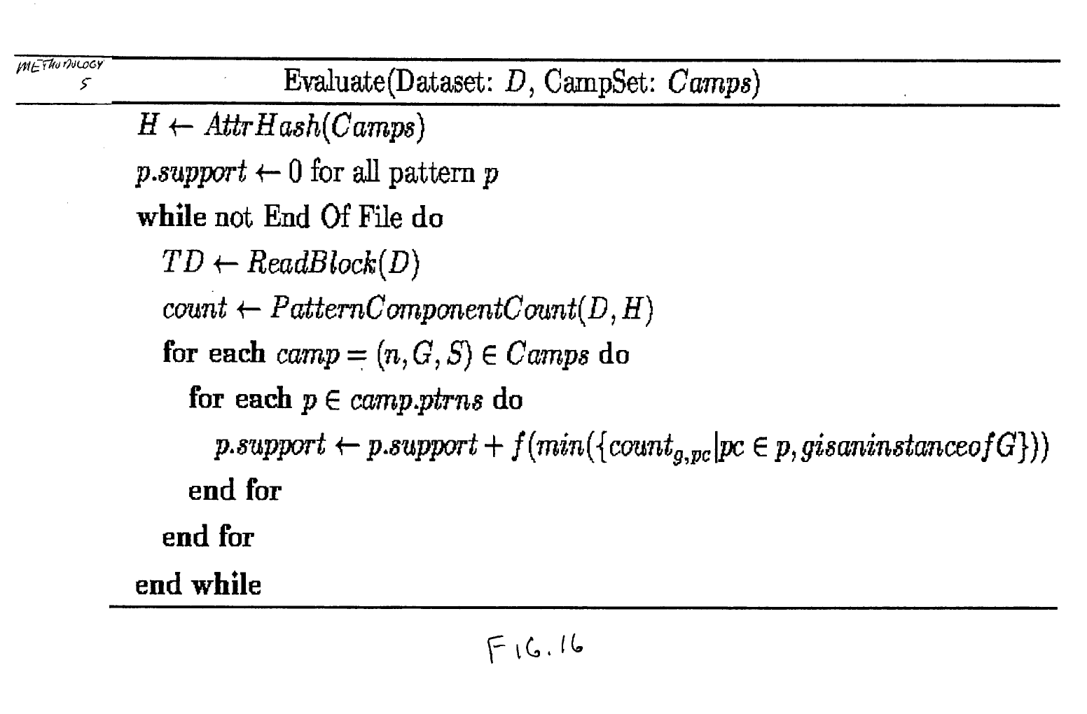

Methodology 5, Evaluate, computes the support level of candidate patterns. This methodology is shown in FIG. 16. Each pattern component is checked in turn. The resulting support level is the minimum of ƒ applied to the minimum of the count of each pattern component.

Methodology 6, AttrHash, builds a data structure to facilitate pattern counting. The input is the mining camps with all the candidate patterns. The output is a hash table, which is a type of data structure. When scanning the data entries, the program will use the hash table to match patterns.

Methodology 7, PatternComponentCount, builds the count matrix for each pattern component. A pattern component is a set of |S| attribute values, and it is ‘satisfied’ by a tuple if all the values appear in the corresponding attributes of the tuple. An array Sat_{pc} is used to store the number of attribute values satisfied by the current tuple. For each attribute value a_k in the tuple, all the pattern components that have constraint A_k=a_k are retrieved from the hash table for attribute k, and the Sat count of the pattern component is increased by 1. A pattern component is satisfied by the tuple if all of its constraints are satisfied, and support of the pattern component is increased by 1.

One remaining issue is how to choose a set of mining camps to be mined in a pass of data scan. A very natural design, as adopted in MAM, is to mine camps on same level in one data scan because each camp has to wait for the result of camps in the previous level. This design is reflected in Methodology 1 and Methodology 5.

This section is concluded by describing some additional efficiencies that can be obtained. First, note that if the aggregating function is Type-2 downward closed, the patterns of (1, {T}∪G,S) and (1,{T},S) are identical because the number of one-item instances is not affected by grouping. Also, observe that if a mining camp has a predecessor of any type with no pattern, the camp has no pattern either. This is a direct result of the downward closure property.

Although illustrative embodiments of the present invention have been described herein with reference to the accompanying drawings, it is to be understood that the invention is not limited to those precise embodiments, and that various other changes and modifications may be performed therein by one skilled in the art without departing from the scope or spirit of the invention.

What is claimed is:

1. A method for processing data having a plurality of attributes, comprising the steps of:
defining a plurality of groups for the data by performing at least the following steps for each group to be defined:
selecting a first subset of the attributes to be first attributes; and
selecting a second subset of the attributes to be second attributes; and
determining patterns occurring a predetermined number of times in the data by using the defined groups.

2. The method of claim 1, wherein the first attributes are grouping attributes.

3. The method of claim 1, wherein the second attributes are itemizing attributes.

4. The method of claim 1, wherein the data comprise a plurality of records, each record comprising the plurality of attributes.

5. The method of claim 4, wherein an instance of a pattern is a set of records, each record in the set having first attributes that are the same and second attributes that are the same.

6. The method of claim 1, wherein the first and second subsets are selected to be non-intersecting.

7. The method of claim 6, wherein the first and second attributes are selected so that all of the plurality of attributes are selected.

8. The method of claim 1, wherein the groups are mining camps, the mining camps defining a mining space, each of the mining camps further comprising a number of patterns.

9. The method of claim 8, wherein the step of determining patterns further comprises the step of using an aggregating function to determine a number of pattern instances of a pattern.

10. The method of claim 8, wherein the step of determining patterns further comprises the step of dividing the mining camps into levels.

11. The method of claim 10, wherein the step of determining patterns further comprises the steps of:
(1) generating a plurality of mining camps for a level;
(2) generating candidate patterns for each mining camp;
(3) computing support for candidate patterns;
(4) eliminating candidates with low support;
(5) determining if a new pattern has been found;
(6) performing steps (1) through (5) when a new pattern has been found; and
(7) stopping the method when a new pattern has not been found.

12. The method of claim 10, wherein the step of determining patterns further comprises the step of defining connections among mining camps through predecessor and successor relationships.

13. The method of claim 12, wherein the relationships comprise a change in one or more of the following between first and second mining camps: (a) the number of records, (b) a first attribute, and (c) a second attribute.

14. The method of claim 13, wherein the step of determining patterns further comprises the step of using the relationships to search for the patterns.

15. The method of claim 14, wherein, for any two mining camps, there is at most one of each predecessor relationships (a), (b), and (c).

16. The method of claim 15, wherein the step of using the relationships further comprises the step of performing different candidate generation steps depending on which type of predecessor relationship is present for a selected one of the mining camps.

17. The method of claim 1, wherein taxonomies or functional dependencies are predefined, and wherein the step of determining patterns further comprises the step of using the predefined taxonomies or functional dependencies when determining patterns.

18. An apparatus for processing data having a plurality of attributes, comprising:
at least one processor operable to:
define a plurality of groups for the data by performing at least the following steps for each group to be defined:
select a first subset of the attributes to be first attributes; and
select a second subset of the attributes to be second attributes; and
determine patterns occurring a predetermined number of times in the data by using the defined groups.

19. The apparatus of claim 18, wherein the first attributes are grouping attributes.

20. The apparatus of claim 18, wherein the second attributes are itemizing attributes.

21. The apparatus of claim 18, wherein the data comprise a plurality of records, each record comprising the plurality of attributes.

22. The apparatus of claim 18, wherein the first and second subsets are selected to be non-intersecting.

23. The apparatus of claim 18, wherein the groups are mining camps, the mining camps defining a mining space, each of the mining camps further comprising a number of patterns.

24. The apparatus of claim 23, wherein the at least one processor is further operable, when determining patterns, to define connections among mining camps through predecessor and successor relationships.

25. The apparatus of claim 18, wherein taxonomies or functional dependencies are predefined, and wherein the at least one processor is further operable, when determining patterns, to use the predefined taxonomies or functional dependencies when determining patterns.

26. An article of manufacture for processing data having a plurality of attributes, comprising:
a computer-readable medium having computer-readable code means embodied thereon, the computer-readable program code means comprising:
a step to define a plurality of groups for the data by performing at least the following steps for each group to be defined:
a step to select a first subset of the attributes to be first attributes; and
a step to select a second subset of the attributes to be second attributes; and
a step to determine patterns occurring a predetermined number of times in the data by using the defined groups.
